(19) United States
(12) Patent Application Publication
(10) Pub. No.: US 2024/0229819 A1
(43) Pub. Date: Jul. 11, 2024

(54) COMPRESSOR WHEEL MOUNTING STRUCTURE AND SUPERCHARGER

(71) Applicant: MITSUBISHI HEAVY INDUSTRIES ENGINE & TURBOCHARGER, LTD., Sagamihara-shi, Kanagawa (JP)

(72) Inventors: Keigo SAKAMOTO, Tokyo (JP); Eigo KATO, Tokyo (JP); Shigeyoshi SAKUMA, Tokyo (JP); Youji AKIYAMA, Sagamihara-shi (JP); Jun SUZUKI, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 18/288,912

(22) PCT Filed: Jun. 16, 2021
(86) PCT No.: PCT/JP2021/022876

§ 371 Date: Oct. 30, 2023

(51) Int. Cl. F04D 29/28; F04D 17/10; F04D 29/054

(52) U.S. Cl. CPC F04D 29/284; F04D 17/10; F04D 29/054

(57) ABSTRACT

The back surface of a hub of a compressor wheel mounting structure according to the present invention comprises a recessed surface which is formed from the outer peripheral end of a flat surface to the outer peripheral edge of the back surface. The recessed surface includes: a first line segment region which extends from the outer peripheral end of the flat surface, which is one end, and toward the other side in the axial direction and in which a curved line having an inclination angle θ1 that is not more than 45 degrees with respect to the axial direction and that becomes greater toward d said other side in the axial direction is at least formed at a position including the other end of the first line segment region; and a second line segment region which extends from said other end of the first line segment region and toward the outer peripheral side in the radial direction and in which a curved line having an inclination angle θ2 that is 45-90 degrees with respect to the axial direction and that becomes greater toward the outer peripheral side is at least formed at a position including a connection part with the first line segment region. Said other end of the first line segment region is provided at a position more to the inner peripheral side than ½ the outer dimension of the back surface of the hub in a direction perpendicular to the axial direction.

### TECHNICAL FIELD

The present disclosure relates to a compressor wheel mounting structure and a supercharger.

### BACKGROUND ART

In some cases, a compressor wheel mounted on a supercharger includes a hub having a through-hole penetrating in an axial direction, and a plurality of blades provided on an outer peripheral surface of the hub. As the compressor wheel mounting structure, a so-called through-bore structure is known as follows. A rotary shaft is inserted into the through-hole formed in the hub, and a nut is screwed into a protruding portion protruding from a wheel front edge end of the rotary shaft. In this manner, the compressor wheel is mechanically coupled to the rotary shaft (for example, PTL 1).

PTL 1 discloses a technique in which two large-diameter portions are formed across a small-diameter portion in a portion inserted into the through-hole of the rotary shaft. An axial center of the compressor wheel is stabilized by fitting the two large-diameter portions into the through-hole.

### CITATION LIST

### Patent Literature

[PTL 1] Japanese Patent No. 6566043

### SUMMARY OF INVENTION

### Technical Problem

In fitting portions between each of the two large-diameter portions and the through-hole which are disclosed in PTL 1, a fitting portion on a back surface side of the compressor wheel is a portion in which centrifugal stress or a temperature is high during an operation of the supercharger. Therefore, there is a possibility that the fitting portion may be disengaged during the operation of the supercharger. In addition, the fitting portion on the back surface side of the compressor wheel is plastically deformed due to high centrifugal stress, and there is a possibility that the fitting portion may be disengaged even when the supercharger is stopped. When the fitting portion is disengaged, there is a possibility that balance of the compressor wheel may deteriorate.

In view of the above-described circumstances, an object of at least one embodiment of the present disclosure is to provide a compressor wheel mounting structure and a supercharger which can reduce a balance change risk in a compressor wheel.

### Solution to Problem

According to an embodiment of the present disclosure, there is provided a compressor wheel mounting structure including a rotary shaft, a sleeve mounted on an outer peripheral surface of the rotary shaft, and a compressor wheel including a hub having a through-hole into which the rotary shaft is inserted along an axial direction, and a plurality of blades provided on an outer peripheral surface of the hub. The outer peripheral surface of the rotary shaft and the through-hole of the hub are joined through interference-fit. A back surface of the hub includes a flat surface including a contact surface which protrudes to one side in the axial direction with respect to an outer peripheral edge of the back surface and which comes into contact with the sleeve, and a recessed surface formed from an outer peripheral end of the flat surface to the outer peripheral edge of the back surface, the recessed surface including a first line segment region extending from one end toward the other side in the axial direction when the outer peripheral end of the flat surface is defined as the one end, in the first line segment region, an inclination angle θ1 with respect to the axial direction being 45 degrees or smaller, and a curved line in which the inclination angle θ1 increases toward the other side in the axial direction being formed at least at a position including the other end of the first line segment region, and a second line segment region extending from the other end of the first line segment region toward an outer peripheral side in a radial direction, in the second line segment region, an inclination angle θ2 with respect to the axial direction being 45 degrees or larger and 90 degrees or smaller, and a curved line in which the inclination angle θ2 increases toward the outer peripheral side being formed at least at a position including a connecting portion connected to the first line segment region. The other end of the first line segment region is provided at a position on an inner peripheral side with respect to ½ of an outer dimension of the back surface of the hub in a direction orthogonal to the axial direction.

According to an embodiment of the present disclosure, there is provided a supercharger including the compressor wheel mounting structure.

### Advantageous Effects of Invention

According to at least one embodiment of the present disclosure, there is provided a compressor wheel mounting structure and a supercharger which can reduce a balance change risk in a compressor wheel.

### BRIEF DESCRIPTION OF DRAWINGS

FIG. 1 is a schematic sectional view taken along an axis of a supercharger according to an embodiment of the present disclosure.

FIG. 2 is a schematic sectional view taken along an axis of a compressor wheel mounting structure according to the embodiment of the present disclosure.

FIG. 3 is a schematic sectional view taken along the axis of the compressor wheel mounting structure according to the embodiment of the present disclosure.

FIG. 4 is a schematic sectional view taken along an axis of a compressor wheel mounting structure according to a comparative example.

FIG. 5 is a view for describing a radial displacement amount of a compressor wheel illustrated in FIG. 4.

FIG. 6 is a contour diagram of a plastic strain generated in the compressor wheel illustrated in FIG. 4.

FIG. 7 is a view for describing a radial displacement amount of the compressor wheel illustrated in FIG. 2.

FIG. 8 is a contour diagram of a plastic strain generated in the compressor wheel illustrated in FIG. 2.

FIG. 9 is a schematic sectional view taken along the axis of the compressor wheel mounting structure having a one-side joint according to the embodiment of the present disclosure.

FIG. 10 is a schematic sectional view taken along the axis of the compressor wheel mounting structure having the one-side joint according to the embodiment of the present disclosure.

FIG. 11 is a view for describing a radial displacement amount of the compressor wheel illustrated in FIG. 10.

FIG. 12 is a schematic sectional view taken along the axis of the compressor wheel mounting structure having a center-side joint according to the embodiment of the present disclosure.

FIG. 13 is a schematic sectional view taken along the axis of the compressor wheel mounting structure having a plurality of joints according to the embodiment of the present disclosure.

FIG. 14 is a schematic sectional view taken along the axis of the compressor wheel mounting structure having the plurality of joints according to the embodiment of the present disclosure.

FIG. 15 is a schematic sectional view taken along the axis of the compressor wheel mounting structure having the plurality of joints according to the embodiment of the present disclosure.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure. For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained. For example, expressions representing shapes such as a quadrangular shape and a cylindrical shape not only represent the shapes such as the quadrangular shape and the cylindrical shape in a geometrically strict sense, but also represent shapes including an uneven portion or a chamfered portion within a range where the same effect can be obtained.

Meanwhile, expressions of “being provided with”, “including”, or “having” one component are not exclusive expressions excluding existence of other components.

The same reference numerals may be assigned to the same configurations, and description thereof may be omitted.

### (Compressor Wheel Mounting Structure)

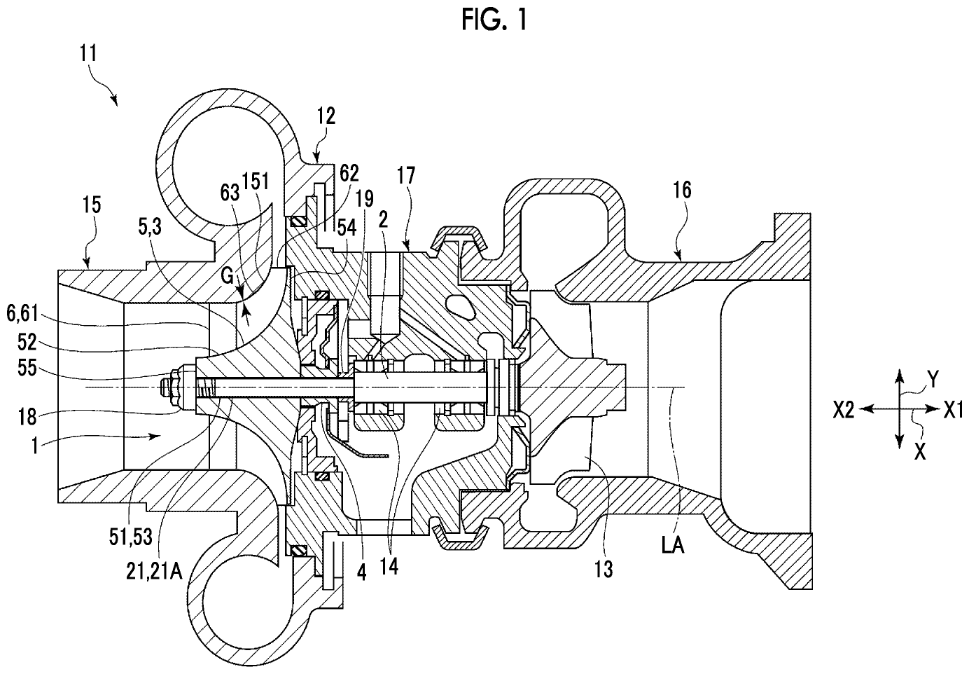

FIG. 1 is a schematic sectional view taken along an axis of a supercharger according to an embodiment of the present disclosure. As illustrated in FIG. 1, a compressor wheel mounting structure 1 according to some embodiments includes a rotary shaft 2, a compressor wheel 3 mounted on an outer peripheral surface 21 of the rotary shaft 2, and a sleeve 4 mounted on the outer peripheral surface 21 of the rotary shaft 2. The sleeve 4 is attached to the rotary shaft 2 on a back surface 54 side (right side in the drawing) of the compressor wheel 3.

Hereinafter, a direction in which an axis LA of the rotary shaft 2 extends is defined as an axial direction X. In the axial direction X, a side where the sleeve 4 is located with respect to the compressor wheel 3 (center right side in FIG. 1) is defined as one side X1, and a side in the axial direction X where the compressor wheel 3 is located with respect to the sleeve 4 (center left side in FIG. 1) is defined as the other side X2. The compressor wheel 3 is attached to the other side X2 of the rotary shaft 2. A radial direction Y of the rotary shaft 2 is a direction orthogonal to the axial direction X with reference to the axis LA.

### (Supercharger)

The compressor wheel mounting structure 1 is mounted on a supercharger 11 as illustrated in FIG. 1. In other words, the supercharger 11 includes the compressor wheel mounting structure 1. Specifically, the supercharger 11 includes the rotary shaft 2, the compressor wheel 3, the sleeve 4, and a casing 12 that rotatably accommodates the rotary shaft 2, the compressor wheel 3, and the sleeve 4.

In the illustrated embodiment, the supercharger 11 includes a turbocharger for an automobile. As illustrated in FIG. 1, the supercharger (turbocharger) 11 further includes a turbine blade 13 mounted on the outer peripheral surface 21 of the rotary shaft 2, and a bearing 14 that rotatably supports the rotary shaft 2. The turbine blade 13 is mechanically coupled to the one side X1 of the rotary shaft 2 in the axial direction X. The compressor wheel 3 is mechanically coupled to the other side X2 of the rotary shaft 2 in the axial direction X. The turbine blade 13 is provided coaxially with the compressor wheel 3. The compressor wheel 3 and the turbine blade 13 are provided coaxially with each other, and are integrally rotatable via the rotary shaft 2. The rotary shaft 2 is rotatably supported by the bearing 14 disposed between the compressor wheel 3 and the turbine blade 13 in the axial direction X.

The casing 12 includes a compressor housing 15 that accommodates the compressor wheel 3, a turbine housing 16 that accommodates the turbine blade 13, and a bearing housing 17 that accommodates the bearing 14. The bearing housing 17 is disposed between the compressor housing 15 and the turbine housing 16, and is mechanically coupled to each of the compressor housing 15 and the turbine housing 16 by a fastening member such as a bolt or a V-clamp.

The supercharger (turbocharger) 11 rotates the turbine blade 13 by using energy of an exhaust gas introduced into the turbine housing 16 from an exhaust gas generator (for example, an internal combustion engine such as an engine) (not illustrated). The compressor wheel 3 is coupled to the turbine blade 13 via the rotary shaft 2. Therefore, the compressor wheel 3 rotates in conjunction with rotation of the turbine blade 13. The supercharger (turbocharger) 11 compresses a fluid (for example, combustion air) introduced into the compressor housing 15 by rotating the compressor wheel 3, and supplies the compressed fluid to a fluid supply destination (for example, the internal combustion engine such as the engine).

### (Compressor Wheel)

As illustrated in FIG. 1, the compressor wheel 3 includes a hub 5 having a through-hole 51 into which the rotary shaft 2 is inserted along the axial direction X, and a plurality of blades (full blades) 6 provided on an outer peripheral surface 52 of the hub 5. The hub 5 is mechanically fixed to the other side X2 of the rotary shaft 2. Therefore, the hub 5 and the plurality of blades 6 can rotate integrally with the rotary shaft 2. The compressor wheel 3 includes a centrifugal impeller configured to guide the fluid introduced outward in the radial direction Y from the other side X2 in the axial direction X.

The hub 5 has the outer peripheral surface 52, an inner peripheral surface 53 forming the through-hole 51, the back surface 54 formed on the one side X1 with respect to the outer peripheral surface 52, and the other side flat surface 55 formed on the other side X2 with respect to the outer peripheral surface 52 and extending along the radial direction Y. The through-hole 51 is formed from the other side flat surface 55 to the back surface 54. The outer peripheral surface 52 is formed in a recessed and curved shape in which a distance of the rotary shaft 2 from the axis LA increases toward the one side X1 from the other side X2 in the axial direction X.

Each of the plurality of blades 6 has a leading edge 61 extending along the radial direction from the outer peripheral surface 52 on the other side X2 of the hub 5, a trailing edge 62 extending along the radial direction from the outer peripheral surface 52 on the one side X1 of the hub 5, and a tip-side edge 63 extending from an outer peripheral end of the leading edge 61 to an outer peripheral end of the trailing edge 62. The tip-side edge 63 is formed in a recessed and curved shape in which a distance of the rotary shaft 2 from the axis LA increases toward the one side X1 from the other side X2 in the axial direction X. In the tip-side edge 63, a gap G (clearance) is formed to face the tip-side edge 63 between the tip-side edge 63 and a shroud surface 151 of the compressor housing 15 curved in a projecting shape.

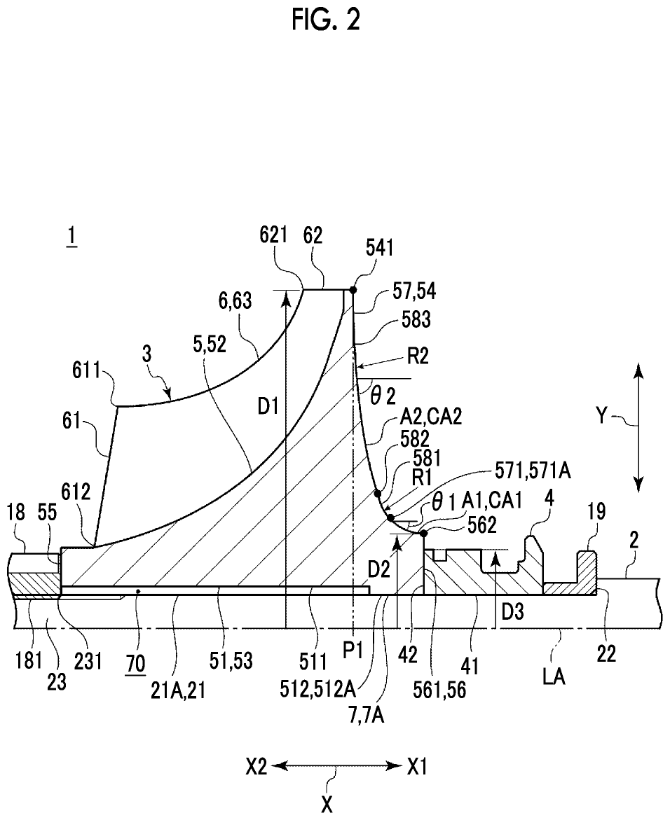

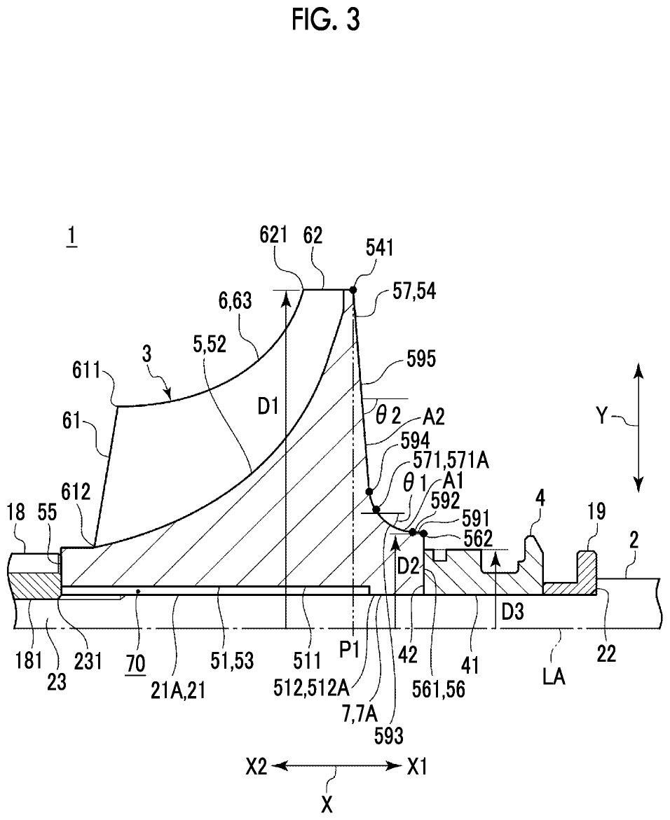

FIGS. 2 and 3 are schematic sectional views taken along an axis of the compressor wheel mounting structure according to the embodiment of the present disclosure.

As illustrated in FIGS. 2 and 3, the compressor wheel mounting structure 1 may further include an annular nut member 18 having a female screw portion 181 formed on an inner peripheral surface, and a thrust ring 19 mounted on the outer peripheral surface 21 on the one side X1 with respect to the sleeve 4 of the rotary shaft 2. The rotary shaft 2 has a stepped surface 22 extending along the radial direction on the other side X2. The other side X2 with respect to the stepped surface 22 of the rotary shaft 2 has an outer dimension smaller than that on the one side X1 with respect to the stepped surface 22. In the compressor wheel 3, the other side X2 with respect to the stepped surface 22 of the rotary shaft 2 is inserted into the through-hole 51 of the hub 5, and the other end portion 23 of the rotary shaft 2 protrudes from the other side flat surface 55 of the hub 5. In the compressor wheel 3, the female screw portion 181 of the nut member 18 is screwed to a male screw portion 231 formed on the outer peripheral surface of the other end portion 23 of the rotary shaft 2. In this manner, the compressor wheel 3 is pinched together with the sleeve 4 and the thrust ring 19 between the stepped surface 22 of the rotary shaft 2 and the nut member 18.

The sleeve 4 is formed in a cylindrical shape having a through-hole 41 penetrating along the axial direction. The sleeve 4 is disposed between the compressor wheel 3 and the stepped surface 22 of the rotary shaft 2, and the rotary shaft 2 is inserted into the through-hole 41. The sleeve 4 has an end surface 42 extending along the radial direction on the other side in the axial direction, and the end surface 42 is in contact with a contact surface 561 (back surface 54) of the hub 5.

In the compressor wheel mounting structure 1, the outer peripheral surface 21 of the rotary shaft 2 and the through-hole 51 of the hub 5 are joined through interference-fit. In the illustrated embodiment, the outer peripheral surface 21 of the rotary shaft 2 and the through-hole 51 of the hub 5 are fixed by shrinkage-fit. Specifically, at least a portion of an outer peripheral surface 21A (21) inserted into the through-hole 51 of the rotary shaft 2 is formed with a diameter larger than that of the through-hole 51, or at least a portion of the through-hole 51 is formed with a diameter smaller than that of the outer peripheral surface 21A (21) inserted into the through-hole 51 of the rotary shaft 2. The through-hole 51 of the hub 5 is heated to expand and widen the diameter of the through-hole 51 so that the rotary shaft 2 is fitted. Thereafter, when cooling is performed, the outer peripheral surface 21 of the rotary shaft 2 and the through-hole 51 of the hub 5 are in a fixed state, and are firmly fixed to each other.

The outer peripheral surface 21 of the rotary shaft 2 and the through-hole 51 of the hub 5 are joined through the interference-fit in a portion in an axial range of the through-hole 51. The compressor wheel mounting structure 1 has at least one joint 7 that joins the outer peripheral surface 21 of the rotary shaft 2 and the through-hole 51 of the hub 5 through the interference-fit. A gap 70 is formed in a portion other than the joint 7 between the outer peripheral surface 21 of the rotary shaft 2 and the through-hole 51 of the hub 5. Each of the at least one joint 7 has a predetermined axial length. In a certain embodiment, each of the at least one joint 7 has an axial length of 10% to 20% of an outer dimension D1 of the back surface 54 of the hub 5.

The back surface 54 includes a flat surface 56 including the contact surface 561 that protrudes to the one side X1 in the axial direction with respect to an outer peripheral edge 541 of the back surface 54 and that comes into contact with the sleeve 4, and a recessed surface 57 formed from an outer peripheral edge 562 of the flat surface 56 to the outer peripheral edge 541 of the back surface 54.

### (Compressor Wheel Mounting Structure According to Comparative Example)

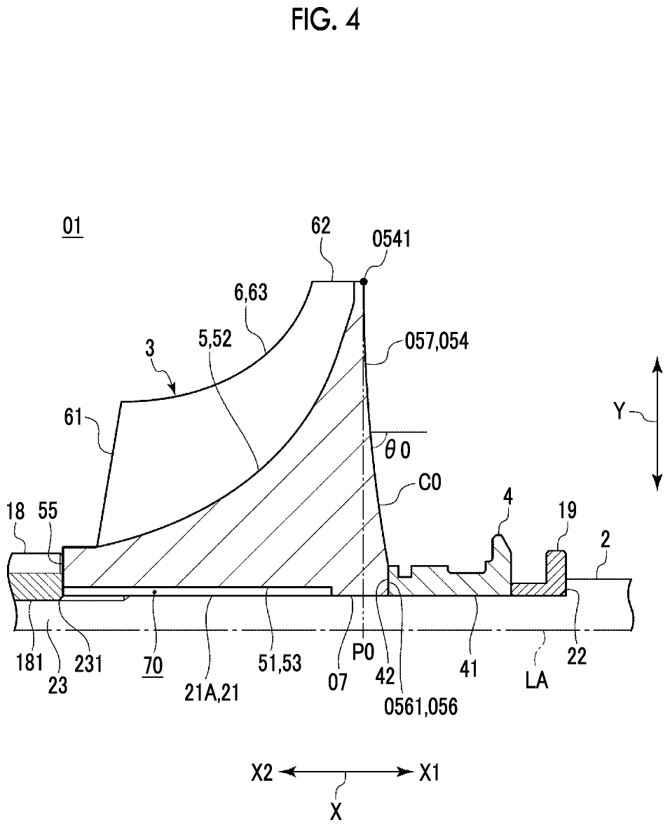

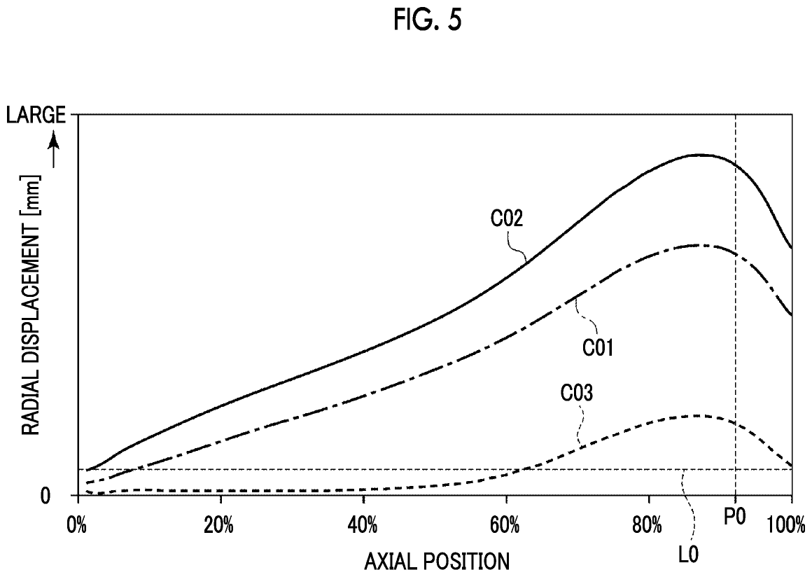

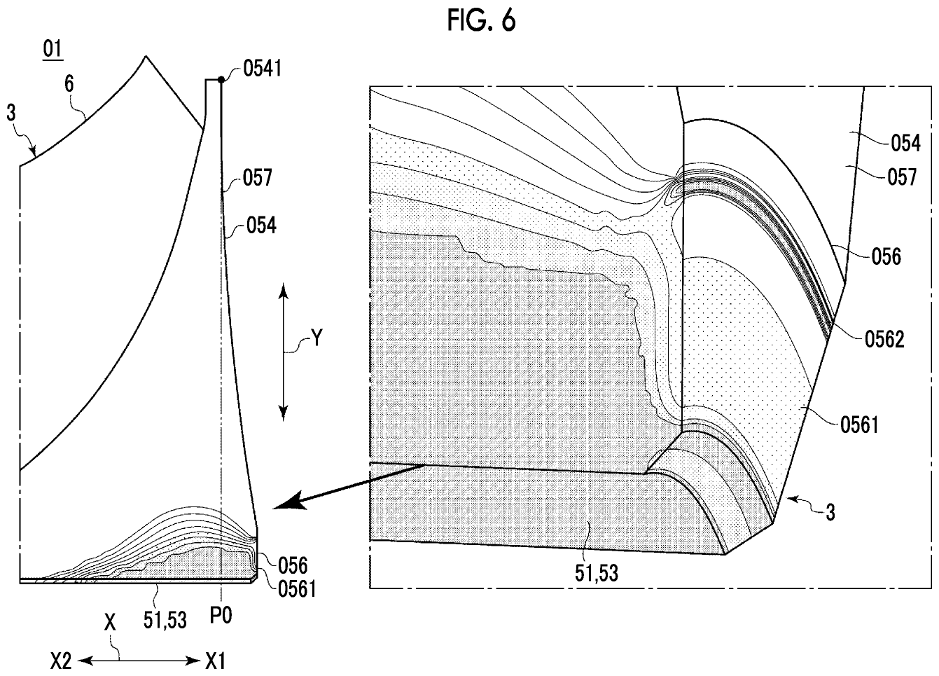

FIG. 4 is a schematic sectional view taken along an axis of a compressor wheel mounting structure according to a comparative example. FIG. 5 is a view for describing a radial displacement amount of a compressor wheel illustrated in FIG. 4. FIG. 6 is a contour diagram of a plastic strain generated in the compressor wheel illustrated in FIG. 4.

In a compressor wheel mounting structure 01 according to the comparative example, a shape of a back surface 054 is different from a shape of the back surface 54 in the compressor wheel mounting structure 1. In addition, in the compressor wheel mounting structure 01 according to the comparative example, an axial position where a joint 07 is formed is different from an axial position where the joint 7 is formed in the compressor wheel mounting structure 1. In the compressor wheel mounting structure 01 illustrated in FIG. 4, the same reference numerals are assigned to elements having the same configuration as those in the compressor wheel mounting structure 1.

As illustrated in FIG. 4, the back surface 054 includes a flat surface 056 including a contact surface 0561 that protrudes to the one side X1 in the axial direction with respect to an outer peripheral edge 0541 of the back surface 054 and that comes into contact with the sleeve 4, and a recessed surface 057 formed from an outer peripheral edge 0562 of the flat surface 056 to the outer peripheral edge 0541 of the back surface 054. In a cross section along the axial direction X, the recessed surface 057 has a curved line C0 in which an inclination angle θ0 with respect to the axial direction is 45 degrees or larger and 90 degrees or smaller, and the inclination angle θ0 increases toward the outer peripheral side. The joint θ7 is formed at a position including an axial position P0 of the outer peripheral edge 0541 of the back surface 054.

In FIG. 5, a graph is illustrated in which the axial position of the through-hole 51 is represented on a horizontal axis and the radial displacement amount of the through-hole 51 is represented on a vertical axis. With regard to the horizontal axis, the axial position of the other side flat surface 55 is set to 0%, and the axial position of the flat surface 056 is set to 100%. A straight line LO in FIG. 5 indicates an interference between the outer peripheral surface 21 of the rotary shaft 2 and the through-hole 51 of the hub 5. A curved line C01 in FIG. 5 indicates a radial displacement amount of the through-hole 51 when a centrifugal force acts on the compressor wheel 3 during an operation of the supercharger 11. A curved line C02 in FIG. 5 indicates a radial displacement amount of the through-hole 51 when heat and the centrifugal force act on the compressor wheel 3 during an operation of the supercharger 11. A curved line C03 in FIG. 5 indicates a radial displacement amount of the through-hole 51 when the supercharger 11 is stopped after the operation.

As illustrated in FIG. 5, the one side X1 of the hub 5 has a larger outer dimension than the other side X2 of the hub 5. Therefore, the centrifugal force greatly acts during the operation of the supercharger 11 (during the rotation of the compressor wheel 3), and a hole diameter of the through-hole 51 is enlarged during the operation of the supercharger 11. In addition, the one side X1 of the hub 5 has a larger amount of thermal expansion generated due to heat acting on the supercharger 11 during the operation (during the rotation of the compressor wheel 3) than the other side X2 of the hub 5, and the hole diameter of the through-hole 51 is enlarged during the operation of the supercharger 11. In the compressor wheel mounting structure 01 according to the comparative example, the hole diameter of the through-hole 51 is enlarged on the one side X1 of the hub 5 due to the centrifugal force or the heat acting during the operation of the supercharger 11. Therefore, in order to maintain joining in the joint 07 during the operation of the supercharger 11, there is a high probability that an increased interference or a cooling structure for cooling the compressor wheel 3 may be required.

As illustrated in FIG. 6, there is a possibility that a plastic strain may be generated over a wide range in the vicinity of the through-hole 51 on the one side X1 of the hub 5 in which centrifugal stress acting during the operation of the supercharger 11 is high. When the hole diameter of the through-hole 51 is enlarged on the one side X1 of the hub 5 due to plastic deformation occurring in the vicinity of the through-hole 51, there is a possibility that joining in the joint 07 is released not only during the operation of the supercharger 11 but also when the supercharger 11 is stopped. In addition, as illustrated in FIG. 6, there is a possibility that the plastic strain may be generated over a wide range on the flat surface 056 during the operation of the supercharger 11. The plastic strain is particularly generated in a portion 0562 which comes into contact with the outer peripheral edge of the sleeve 4 of the contact surface 0561. Due to the plastic deformation occurring on the flat surface 056, there is a possibility that a circumferential position of the compressor wheel 3 may be displaced and balance of the compressor wheel 3 may be changed.

As illustrated in FIGS. 2 and 3, the compressor wheel mounting structure 1 according to some embodiments includes the rotary shaft 2, the compressor wheel 3 including the hub 5 and the plurality of blades 6, and the sleeve 4. The outer peripheral surface 21 of the rotary shaft 2 and the through-hole 51 of the hub 5 are joined through the interference-fit. The back surface 54 of the hub 5 includes the flat surface 56 including the contact surface 561 which protrudes to the one side X1 in the axial direction with respect to the outer peripheral edge 541 of the back surface 54 and which comes into contact with the sleeve 4, and the recessed surface 57 formed from an outer peripheral end 562 of the flat surface 56 to the outer peripheral edge 541 of the back surface 54. As illustrated in FIGS. 2 and 3, the recessed surface 57 includes a first line segment region A1 extending from one end toward the other side X2 in the axial direction when the outer peripheral end 562 of the flat surface 56 is defined as the one end, in the first line segment region A1, the inclination angle θ1 with respect to the axial direction being 45 degrees or smaller, and a curved line CA1 in which the inclination angle θ1 increases toward the other side X2 in the axial direction being formed at least at a position including the other end 571 of the first line segment region A1, and a second line segment region A2 extending from the other end 571 of the first line segment region A1 toward an outer peripheral side in the radial direction, in the second line segment region A2, the inclination angle θ2 with respect to the axial direction being 45 degrees or larger and 90 degrees or smaller, and a curved line CA2 in which the inclination angle θ2 increases toward the outer peripheral side being formed at least at a position including a connecting portion 571A connected to the first line segment region A1. In the compressor wheel mounting structure 1, the other end 571 of the first line segment region A1 is provided at a position on the inner peripheral side with respect to ½ of the outer dimension D1 of the back surface 54 of the hub 5 in a direction orthogonal to the axial direction.

Preferably, in a direction orthogonal to the axial direction, the other end 571 of the first line segment region A1 is provided at a position on the outer peripheral side with respect to 20% of the outer dimension D1 of the back surface 54 of the hub 5, and on the inner peripheral side with respect to 40% of the outer dimension D1.

In the illustrated embodiment, one end of the second line segment region A2 is connected to the other end 571 of the first line segment region A1 in the connecting portion 571A, and the other end of the second line segment region A2 is connected to the outer peripheral edge 541 of the back surface 54. In the connecting portion 571A, the inclination angles θ1 and θ2 with respect to the axial direction are 45 degrees. The curved line CA1 may also be formed at a position including one end (the outer peripheral end 562 of the flat surface 56) of the first line segment region A1. That is, the curved line CA1 may be formed from one end to the other end of the first line segment region A1. In addition, the curved line CA2 may be formed at a position including the other end of the second line segment region A2. That is, the curved line CA2 may be formed from one end to the other end of the second line segment region.

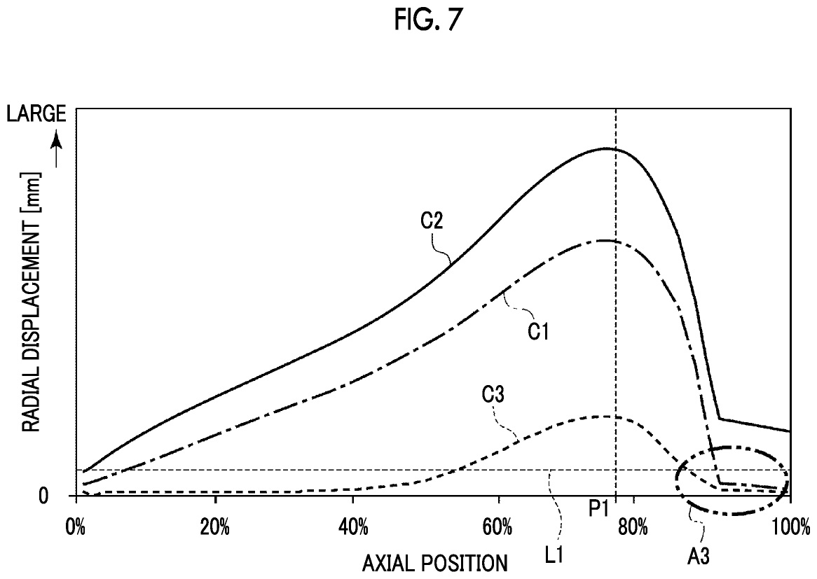

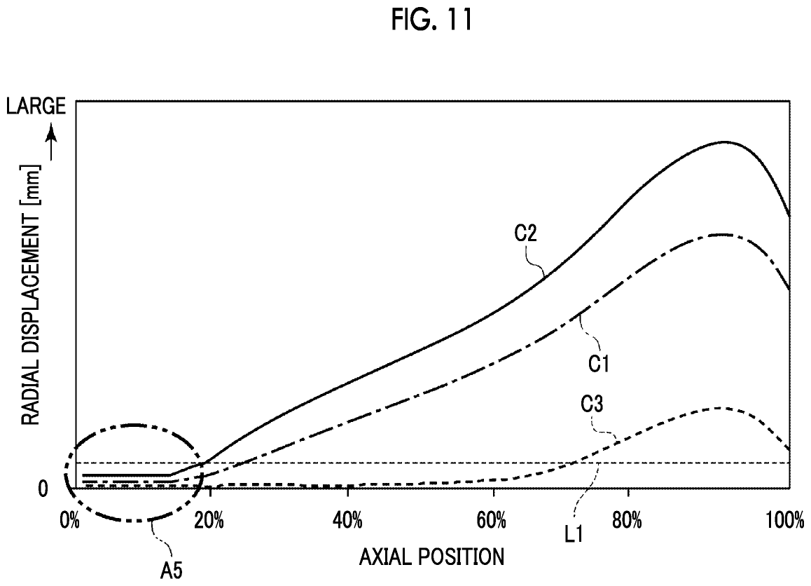

In FIGS. 7 and 11 (to be described later), a graph is illustrated in which the axial position of the through-hole 51 is represented on the horizontal axis and the radial displacement amount of the through-hole 51 is represented on the vertical axis. With regard to the horizontal axis, the axial position of the other side flat surface 55 is set to 0%, and the axial position of the flat surface 56 is set to 100%. The straight line LO in FIGS. 7 and 11 indicates an interference between the outer peripheral surface 21 of the rotary shaft 2 and the through-hole 51 of the hub 5. A curved line C1 in FIGS. 7 and 11 indicates the radial displacement amount of the through-hole 51 when the centrifugal force acts on the compressor wheel 3 during the operation of the supercharger 11. A curved line C2 in FIGS. 7 and 11 indicates the radial displacement amount of the through-hole 51 when the heat and the centrifugal force act on the compressor wheel 3 during the operation of the supercharger 11. A curved line C3 in FIGS. 7 and 11 indicates the radial displacement amount of the through-hole 51 when the supercharger 11 is stopped after the operation.

As illustrated in FIGS. 2 and 3, the back surface 54 of the hub 5 is formed into a shape including the flat surface 56 and the recessed surface 57 including the first line segment region A1 and the second line segment region A2. In this manner, as illustrated in FIG. 7, a region A3 where the acting centrifugal stress is low and the radial displacement amount is low is formed on the back surface portion of the hub 5, which is a portion on the one side X1 in the axial direction with respect to the outer peripheral edge 541 of the back surface 54 of the hub 5. In the region A3, the radial displacement amount when the supercharger 11 is operated and stopped is lower than that at the axial position P0 of the outer peripheral edge 0541 of the back surface 054.

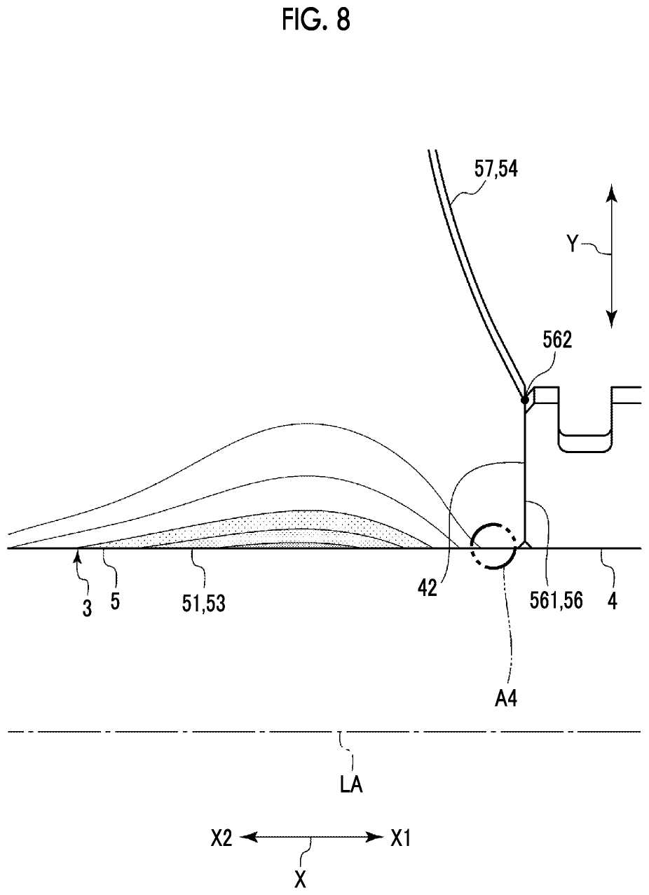

As illustrated in FIGS. 2 and 3, the back surface 54 of the hub 5 is formed into a shape including the flat surface 56 and the recessed surface 57 including the first line segment region A1 and the second line segment region A2. In this manner, as illustrated in FIG. 8, a region A4 in which the plastic strain is less likely to be generated compared to the vicinity of the axial position P0 on the inner peripheral surface 53 is formed in the vicinity of the flat surface 56 on the inner peripheral surface 53 of the through-hole 51. Since the region A4 is formed, the plastic strain generated on the flat surface 56 during the operation of the supercharger 11 can be prevented.

According to the above-described configuration, the back surface 54 of the hub 5 is formed into a shape including the flat surface 56 and the recessed surface 57 including the first line segment region A1 and the second line segment region A2. In this manner, while a strength decrease can be prevented on the back surface portion of the hub 5, which is a portion on the one side X1 in the axial direction with respect to the outer peripheral edge 541 of the back surface 54 of the hub 5, the centrifugal stress acting on the back surface portion of the hub 5 can be reduced. In this manner, during the operation of the supercharger 11 including the mounting structure 1 of the compressor wheel 3, the through-hole 51 of the hub 5 can be prevented from being plastically deformed due to the heat or the centrifugal stress acting on the hub 5. Since the through-hole 51 of the hub 5 is prevented from being plastically deformed, when the supercharger 11 is operated or stopped, it is possible to prevent a change in the balance of the compressor wheel 3 when joining between the outer peripheral surface 21 of the rotary shaft 2 and the through-hole 51 of the hub 5 is released.

As illustrated in FIGS. 2 and 3, the back surface 54 of the hub 5 is formed into a shape including the flat surface 56 and the recessed surface 57 including the first line segment region A1 and the second line segment region A2. In this manner, it is possible to increase an outer dimension D2 of the flat surface 56 and an outer dimension of the end surface 42 which comes into contact with the flat surface 56 of the sleeve 4. A contact area between the flat surface 56 and the end surface 42 can be increased by increasing the outer dimension D2 of the flat surface 56 and the outer dimension of the end surface 42 of the sleeve 4. Therefore, the flat surface 56 can be prevented from being plastically deformed. In some embodiments, an outer dimension D3 of the contact surface 561 is within a range of 10% to 20% of the outer dimension D1 of the back surface 54 of the hub 5.

In some embodiments, as illustrated in FIG. 2, the recessed surface 57 includes a first curved surface 581 formed at a position including the outer peripheral end 562 of the flat surface 56 and having a first curvature R1, and a second curved surface 583 connected to the first curved surface 581 and having a curvature R2 smaller than the first curvature R1.

In the illustrated embodiment, one end of the first curved surface 581 is the outer peripheral end 562 of the flat surface 56, and the other end of the first curved surface 581 is connected to one end of the second curved surface 583 in the connecting portion 582 between the first curved surface 581 and the second curved surface 583. The other end of the second curved surface 583 may be connected to the outer peripheral edge 541 of the back surface 54. The other end may be located on the one side X1 with respect to the outer peripheral edge 541 of the back surface 54. In addition, in the illustrated embodiment, in a direction orthogonal to the axial direction, the connecting portion 582 is provided at a position on the inner peripheral side with respect to ½ of the outer dimension D1 of the back surface 54 of the hub 5.

According to the above-described configuration, the recessed surface 57 is formed into a shape including the first curved surface 581 and the second curved surface 583. In this manner, while a strength decrease can be prevented on the back surface portion of the hub 5, it is possible to reduce the centrifugal stress acting on the back surface portion of the hub 5, particularly, on the flat surface 56 side (the one side in the axial direction) with respect to the connecting portion 582 between the first curved surface 581 and the second curved surface 583.

In some embodiments, as illustrated in FIG. 3, the recessed surface 57 includes a first flat surface 591 formed at a position including the outer peripheral end 562 of the flat surface 56, a curved surface 593 connected to the first flat surface 591, and a second flat surface 595 connected to the curved surface 593 and formed at a position including the outer peripheral edge 541 of the back surface 54.

The first flat surface 591 extends along the axial direction X. The second flat surface 595 extends along the radial direction Y. A connecting portion 592 between the first flat surface 591 and the curved surface 593 is located on the inner peripheral side in the radial direction Y with respect to a connecting portion 594 between the second flat surface 595 and the curved surface 593. The position of the connecting portion 592 in the radial direction Y may be the same as the position of the outer peripheral end 562 of the flat surface 56, or may be located on the outer peripheral side in the radial direction Y with respect to the outer peripheral end 562 of the flat surface 56. In addition, the position of the connecting portion 594 in the axial direction X may be the same as the position of the outer peripheral edge 541 of the back surface 54, or may be located on the one side X1 in the axial direction X with respect to the outer peripheral edge 541 of the back surface 54.

In the illustrated embodiment, in the direction orthogonal to the axial direction, the connecting portion 594 is provided at a position on the inner peripheral side with respect to ½ of the outer dimension D1 of the back surface 54 of the hub 5.

According to the above-described configuration, the recessed surface 57 is formed into a shape including the first flat surface 591, the curved surface 593, and the second flat surface 595. In this manner, while a strength decrease can be prevented on the back surface portion of the hub 5, it is possible to reduce the centrifugal stress acting on the back surface portion of the hub 5, particularly, on the flat surface 56 side (one side X1 in the axial direction) with respect to the connecting portion 594 between the second flat surface 595 and the curved surface 593.

### (One Side Fastening Portion)

In some embodiments, as illustrated in FIGS. 2 and 3, the compressor wheel mounting structure 1 has at least one joint 7 that joins the outer peripheral surface 21 of the rotary shaft 2 and the through-hole 51 of the hub 5 through the interference-fit. The at least one joint 7 includes a one-side joint 7A provided on the one side X1 in the axial direction with respect to the outer peripheral edge 541 of the back surface 54.

In the illustrated embodiment, the through-hole 51 includes a through-hole side large-diameter portion 511 separated in a direction orthogonal to the axial direction X with respect to the outer peripheral surface 21 of the rotary shaft 2, and a through-hole side small-diameter portion 512A (512) provided in the one-side joint 7A and formed with a diameter smaller than that of the through-hole side large-diameter portion 511. In the illustrated example, the through-hole side small-diameter portion 512 is not formed except for in the one-side joint 7A. The one-side joint 7A may be formed at a position including an inner peripheral end of the flat surface 56.

The through-hole side small-diameter portion 512A (512) has an interference with the outer peripheral surface 21A (21) inserted into the through-hole 51 of the rotary shaft 2. The one-side joint 7A is formed in such a manner that the outer peripheral surface 21A of the rotary shaft 2 and the inner peripheral surface of the through-hole side small-diameter portion 512A are joined through the interference-fit.

According to the above-described configuration, the one-side joint 7A is provided on the back surface portion of the hub 5 in which the centrifugal stress acting during the operation of the supercharger 11 is low. There is a low probability that the inner peripheral surface 53 on the back surface portion of the hub 5 may be plastically deformed during the operation of the supercharger 11. Therefore, joining by the one-side joint 7A is maintained both when the supercharger 11 is operated and when the supercharger 11 is stopped. In this manner, a balance change risk in the compressor wheel 3 can be reduced.

### (Other Side Fastening Portion)

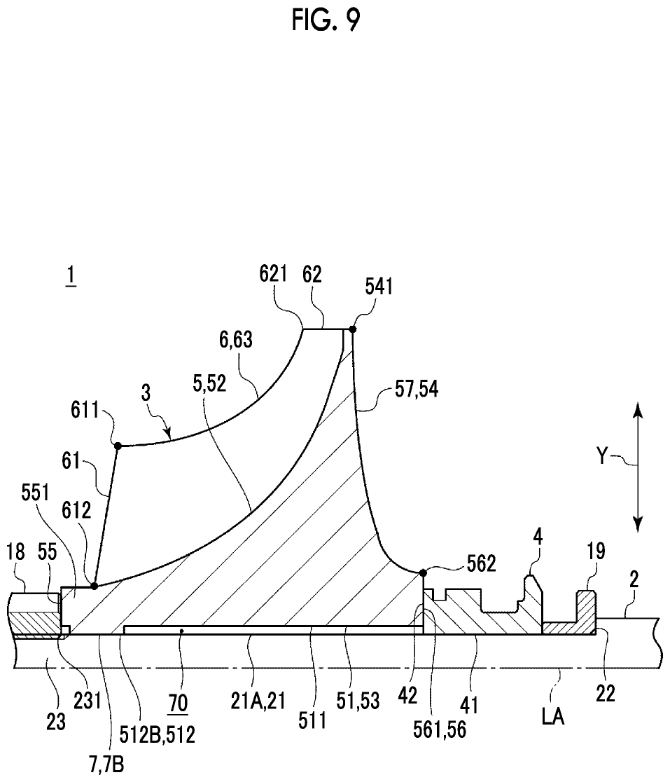

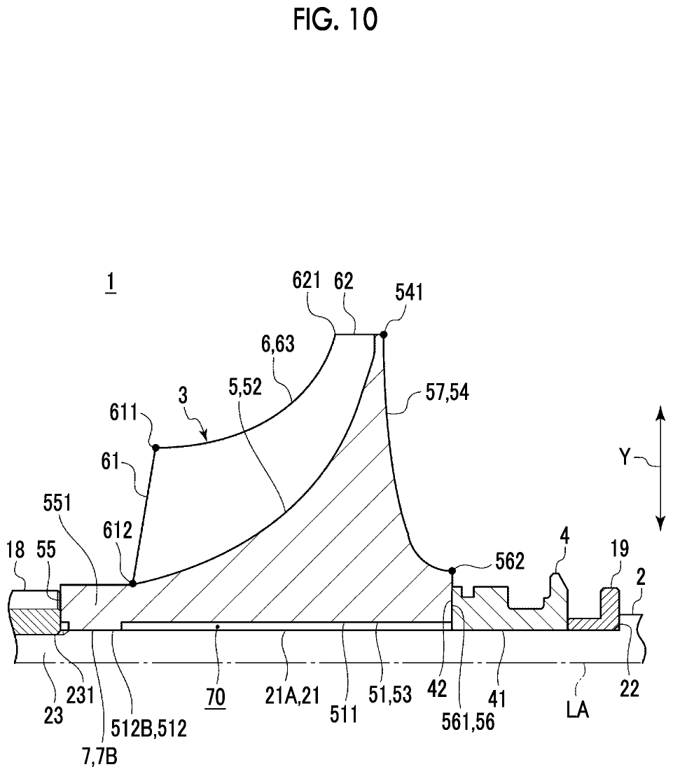

Each of FIGS. 9 and 10 is a schematic sectional view taken along the axis of the compressor wheel mounting structure having the one-side t according to the embodiment of the present disclosure. FIG. 11 is a view for describing the radial displacement amount of the compressor wheel illustrated in FIG. 10.

In some embodiments, as illustrated in FIGS. 9 and 10, the compressor wheel mounting structure 1 has at least one joint 7 that joins the outer peripheral surface 21 of the rotary shaft 2 and the through-hole 51 of the hub 5 through the interference-fit. The at least one joint 7 includes an other-side joint 7B, at least a portion of which is provided on the other side X2 in the axial direction with respect to the leading edge 61 of the blade 6.

In the illustrated embodiment, the through-hole 51 includes a through-hole side large-diameter portion 511 separated in a direction orthogonal to the axial direction X with respect to the outer peripheral surface 21 of the rotary shaft 2, and a through-hole side small-diameter portion 512B (512) provided in the other-side joint 7B and formed with a diameter smaller than that of the through-hole side large-diameter portion 511. In the illustrated example, the through-hole side small-diameter portion 512 is not formed except for in the other-side joint 7B. In the embodiment illustrated in FIG. 9, the other-side joint 7B is formed from an outer peripheral end 611 of the leading edge 61 to the one side X1 in the axial direction. The other-side joint 7B may be formed at a position including an inner peripheral end of the other side flat surface 55.

The through-hole side small-diameter portion 512B (512) has an interference with the outer peripheral surface 21A (21) inserted into the through-hole 51 of the rotary shaft 2. The other-side joint 7B is formed in such a manner that the outer peripheral surface 21A of the rotary shaft 2 and the inner peripheral surface of the through-hole side small-diameter portion 512B are joined through the interference-fit.

According to the above-described configuration, at least a portion of the other-side joint 7B is provided in a front portion of the hub 5 (portion on the other side in the axial direction with respect to the leading edge 61 of the blade 6 of the hub 5) in which the centrifugal stress acting during the operation of the supercharger 11 is low. There is a low probability that the inner peripheral surface 53 in the front portion of the hub 5 may be plastically deformed during the operation of the supercharger 11. Therefore, joining by the other-side joint 7B is maintained both when the supercharger 11 is operated and when the supercharger 11 is stopped. In this manner, a balance change risk in the compressor wheel 3 can be reduced.

In some embodiments, as illustrated in FIG. 10, the hub 5 includes a boss part 551 which protrudes toward the other side X2 in the axial direction with respect to the leading edge 61 of the blade 6, and the other-side joint 7B is provided in the boss part 551. The other-side joint 7B is not formed on the one side X1 in the axial direction with respect to an inner peripheral end 612 of the leading edge 61. Compared to a normal boss part, the boss part 551 may extend to the other side X2 in the axial direction so that the other-side joint 7B can secure a predetermined axial length.

As illustrated in FIG. 11, a region A5 in which the acting centrifugal stress is low and the radial displacement amount is low is formed in the boss part 551 of the hub 5. In the region A5, the radial displacement amount when the supercharger 11 is operated and stopped is lower than that at the axial position P0 of the outer peripheral edge 541 of the back surface 54.

According to the above-described configuration, the other-side joint 7B is provided in the boss part 551 in which the centrifugal stress acting during the operation of the supercharger 11 is low in the front portions of the hub 5. In this manner, compared to when the other-side joint 7B is provided at a position other than the boss part 551 in the front portion, joining by the other-side joint 7B is effectively maintained both when the supercharger 11 is operated and when the supercharger 11 is stopped. In this manner, a balance change risk in the compressor wheel 3 can be effectively reduced.

### (Center Side Fastening Portion)

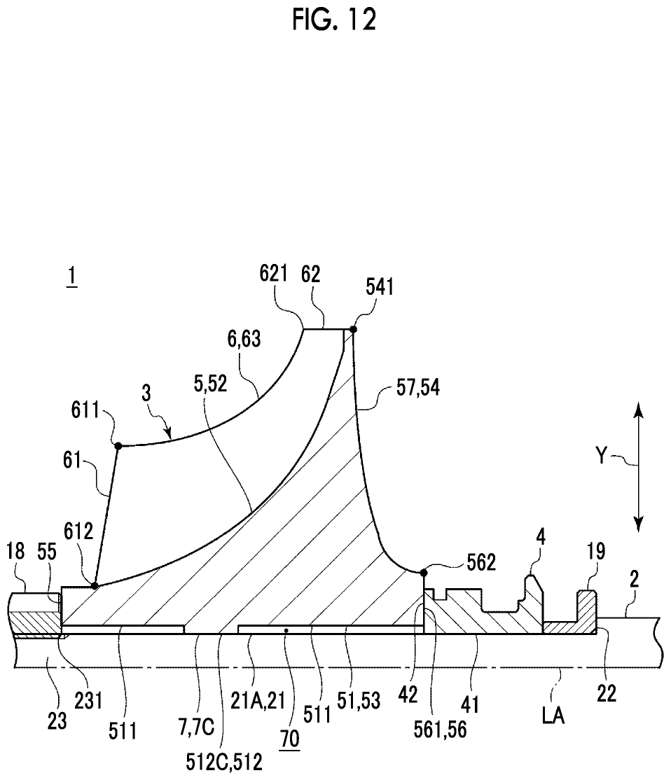

FIG. 12 is a schematic sectional view along the axis of the compressor wheel mounting structure having a center-side joint according to the embodiment of the present disclosure.

In some embodiments, as illustrated in FIG. 12, the compressor wheel mounting structure 1 has at least one joint 7 that joins the outer peripheral surface 21 of the rotary shaft 2 and the through-hole 51 of the hub 5 through the interference-fit. The at least one joint 7 includes a center-side joint 7C provided on the one side X1 in the axial direction with respect to the leading edge 61 of the blade 6, and on the other side X2 in the axial direction with respect to the trailing edge 62 of the blade 6.

In the illustrated embodiment, the through-hole 51 includes the through-hole side large-diameter portion 511 separated in a direction orthogonal to the axial direction X with respect to the outer peripheral surface 21 of the rotary shaft 2, and a through-hole side small-diameter portion 512C (512) provided in the center-side joint 7C and formed with a diameter smaller than that of the through-hole side large-diameter portion 511. In the illustrated example, the through-hole side small-diameter portion 512 is not formed except for in the center-side joint 7C.

The through-hole side small-diameter portion 512C (512) has an interference with the outer peripheral surface 21A (21) inserted into the through-hole 51 of the rotary shaft 2. The center-side joint 7C is formed in such a manner that the outer peripheral surface 21A of the rotary shaft 2 and the inner peripheral surface of the through-hole side small-diameter portion 512C are joined through the interference-fit.

According to the above-described configuration, the center-side joint 7C is provided in a central portion (portion on the one side X1 in the axial direction with respect to the leading edge 61 of the blade 6 of the hub 5 and on the other side X2 in the axial direction with respect to the trailing edge 62 of the blade 6) of the hub 5 in which the centrifugal stress acting during the operation of the supercharger 11 is low. There is a low probability that the inner peripheral surface 53 in the central portion of the hub 5 may be plastically deformed during the operation of the supercharger 11. Therefore, joining by the center-side joint 7C is maintained both when the supercharger 11 is operated and when the supercharger 11 is stopped. In this manner, a balance change risk in the compressor wheel 3 can be reduced.

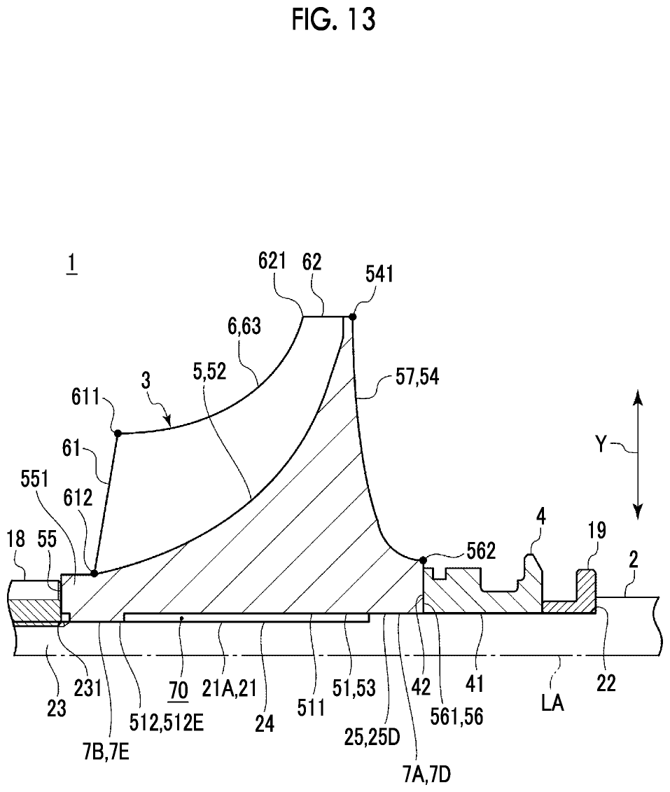

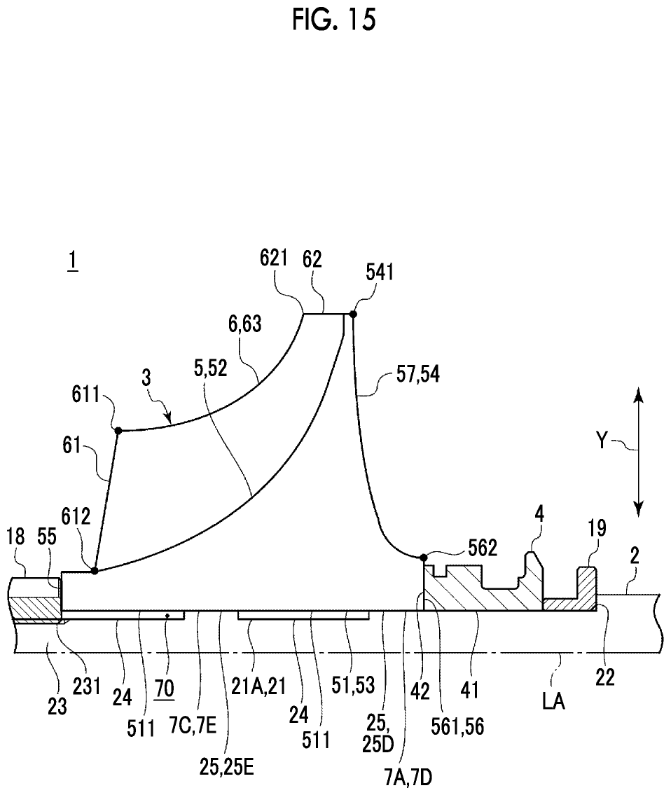

In some of the above-described embodiments, the joint 7 is formed by providing the through-hole side small-diameter portion 512 formed with a diameter smaller than that of the through-hole side large-diameter portion 511 in the through-hole 51. However, in some other embodiments, for example, as illustrated in FIGS. 13 and 15, the joint 7 may be formed by providing a shaft side small-diameter portion 24 and a shaft side large-diameter portion 25 (25D and 25E) formed with a diameter larger than that of the shaft side small-diameter portion 24 in a portion inserted into the through-hole 51 of the rotary shaft 2. The shaft side large-diameter portion 25 has an interference with the inner peripheral surface 53 of the through-hole 51.

### (Plurality of Joints)

Each of FIGS. 13 to 15 is a schematic sectional view taken along the axis of the compressor wheel mounting structure having a plurality of joints according to the embodiment of the present disclosure.

In some embodiments, as illustrated in FIGS. 13 to 15, at least one joint 7 of the compressor wheel mounting structure 1 includes a first joint 7D and a second joint 7E provided on the other side X2 in the axial direction with respect to the first joint 7D.

As illustrated in FIGS. 13 to 15, the first joint 7D may be the one-side joint 7A, and the second joint 7E may be either the other-side joint 7B or the center-side joint 7C. In some other embodiments, the first joint 7D may be the center-side joint 7C, and the second joint 7E may be the other-side joint 7B.

According to the above-described configuration, in the compressor wheel mounting structure 1, the joints 7 (the first joint 7D and the second joint 7E) are provided at a plurality of locations in the axial direction X. In this manner, the compressor wheel 3 can be prevented from being tilted with respect to the rotary shaft 2, and an axial center of the compressor wheel 3 can be accurately held. In this manner, a balance change risk in the compressor wheel 3 can be reduced.

In some embodiments, as illustrated in FIG. 13, the at least one joint 7 includes the first joint 7D and the second joint 7E. The portion inserted into the through-hole 51 in the rotary shaft 2 includes the shaft side small-diameter portion 24 facing the inner peripheral surface 53 of the through-hole 51, and the shaft side large-diameter portion 25D (25) provided in the first joint 7D and formed with a diameter larger than that of the shaft side small-diameter portion 24. The through-hole 51 includes the through-hole side large-diameter portion 511 separated in a direction orthogonal to the axial direction with respect to the shaft side small-diameter portion 24, and the through-hole side small-diameter portion 512E (512) provided in the second joint 7E and formed with a diameter smaller than that of the through-hole side large-diameter portion 511.

In the embodiment illustrated in FIG. 13, the first joint 7D includes the one-side joint 7A, and the second joint 7E includes the other-side joint 7B.

According to the above-described configuration, the first joint 7D (7A in the illustrated example) is formed in such a manner that the outer peripheral surface of the shaft side large-diameter portion 25D and the inner peripheral surface of the through-hole side large-diameter portion 511 are joined through the interference-fit. In addition, the second joint 7E (7B in the illustrated example) is formed in such a manner that the outer peripheral surface of the shaft side small-diameter portion 24 and the inner peripheral surface of the through-hole side small-diameter portion 512 are joined through the interference-fit. The diameter of the rotary shaft 2 in the first joint 7D is increased, and the diameter of the through-hole 51 in the second joint 7E is decreased. In this manner, the rotary shaft 2 is easily inserted into the through-hole 51 of the compressor wheel 3 from the one side X1 toward the other side X2 in the axial direction. In this manner, the compressor wheel 3 and the rotary shaft 2 are satisfactorily assembled. In addition, according to the above-described configuration, compared to when a plurality of the shaft side large-diameter portions 25 (25D and 25E) are formed in the rotary shaft 2, or when a plurality of the through-hole side small-diameter portions 512 (512D and 512E) are formed in the hub 5, the rotary shaft 2 and the hub 5 are more easily formed. Therefore, manufacturing costs of the rotary shaft 2 or the hub 5 can be reduced.

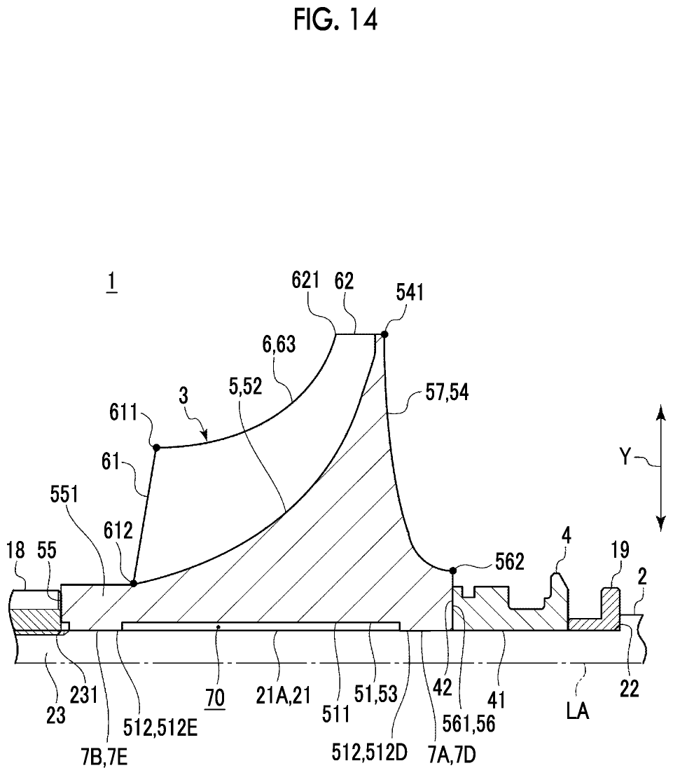

In some embodiments, as illustrated in FIG. 14, the at least one joint 7 includes the first joint 7D and the second joint 7E. The through-hole 51 includes the through-hole side large-diameter portion 511 separated in a direction orthogonal to the axial direction with respect to the rotary shaft 2, the first through-hole side small-diameter portion 512D (512) provided in the first joint 7D and formed with a diameter smaller than the through-hole side large-diameter portion 511, and the second through-hole side small-diameter portion 512E (512) provided in the second joint 7E and formed with a diameter smaller than that of the through-hole side large-diameter portion 511.

The through-hole side large-diameter portion 511 is formed between the first through-hole side small-diameter portion 512D and the second through-hole side small-diameter portion 512E. In the embodiment illustrated in FIG. 14, the first joint 7D includes the one-side joint 7A, and the second joint 7E includes the other-side joint 7B provided in the boss part 551.

According to the above-described configuration, the first joint 7D (7A in the illustrated example) is formed in such a manner that the inner peripheral surface of the first through-hole side small-diameter portion 512D and the outer peripheral surface 21 of the rotary shaft 2 are joined through the interference-fit. In addition, the second joint 7E (7B in the illustrated example) is formed in such a manner that the inner peripheral surface of the second through-hole side small-diameter portion 512E and the outer peripheral surface 21 of the rotary shaft 2 are joined through the interference-fit. In this case, the shaft side large-diameter portion 25 as described above may not be formed in the rotary shaft 2, and the rotary shaft 2 is easily formed. Therefore, manufacturing costs of the rotary shaft 2 can be reduced.

In some embodiments, as illustrated in FIG. 15, the at least one joint 7 includes the first joint 7D and the second joint 7E. The portion inserted into the through-hole 51 in the rotary shaft 2 includes the shaft side small-diameter portion 24 separated in a direction orthogonal to the axial direction with respect to the inner peripheral surface 53 of the through-hole 51, the first shaft side large-diameter portion 25D (25) provided in the first joint 7D and formed with a diameter larger than the shaft side small-diameter portion 24, and the second shaft side large-diameter portion 25E (25) provided in the second joint 7E and formed with a diameter larger than that of the shaft side small-diameter portion 24.

The shaft side small-diameter portion 24 is formed between the first shaft side large-diameter portion 25D and the second shaft side large-diameter portion 25E. In the embodiment illustrated in FIG. 15, the first joint 7D includes the one-side joint 7A, and the second joint 7E includes the center-side joint 7C.

According to the above-described configuration, the first joint 7D (7A in the illustrated example) is formed in such a manner that the outer peripheral surface of the first shaft side large-diameter portion 25D and the inner peripheral surface 53 of the through-hole 51 are joined through the interference-fit. In addition, the second joint 7E (7C in the illustrated example) is formed in such a manner that the outer peripheral surface of the second shaft side large-diameter portion 25E and the inner peripheral surface 53 of the through-hole 51 are joined through the interference-fit. In this case, the through-hole side small-diameter portion 512 as described above may not be formed in the through-hole 51 of the hub 5, and the through-hole 51 is easily formed. Therefore, manufacturing costs of the compressor wheel 3 can be reduced.

In some embodiments, as illustrated in FIGS. 13 to 15, the first joint 7D includes the one-side joint 7A provided on the one side X1 in the axial direction with respect to the outer peripheral edge 541 of the back surface 54.

According to the above-described configuration, the first joint 7D is provided on the back surface portion of the hub 5 in which the centrifugal stress acting during the operation of the supercharger 11 is low. There is a low probability that the inner peripheral surface on the back surface portion of the hub 5 may be plastically deformed during the operation of the supercharger 11. Therefore, joining by the first joint 7D is maintained both when the supercharger 11 is operated and when the supercharger 11 is stopped. In addition, the second joint 7E is provided in the front portion or the central portion of the hub 5 in which the centrifugal stress acting on the supercharger 11 during the operation is low. In this manner, joining by the second joint 7E is maintained both when the supercharger 11 is operated and when the supercharger 11 is stopped. Therefore, the compressor wheel 3 can be effectively prevented from being tilted with respect to the rotary shaft 2, and an axial center of the compressor wheel 3 can be accurately held. In this manner, a balance change risk in the compressor wheel 3 can be effectively reduced.

As illustrated in FIG. 1, the supercharger 11 according to some embodiments includes the compressor wheel mounting structure (1). According to the above-described configuration, the through-hole 51 of the hub 5 can be prevented from being plastically deformed due to the heat or the centrifugal stress acting on the hub 5 during the operation of the supercharger 11. In this manner, when the supercharger 11 is operated or stopped, joining between the outer peripheral surface 21 of the rotary shaft 2 and the through-hole 51 of the hub 5 can be prevented from being released. Therefore, a change in the balance of the compressor wheel 3 can be prevented.

The present disclosure is not limited to the above-described embodiments, and also includes a form in which modifications are added to the above-described embodiments or a form in which the embodiments are combined with each other as appropriate.

The contents described in some of the above-described embodiments are understood as follows, for example.

1) The compressor wheel mounting structure (1) according to at least one embodiment of the present disclosure includes the compressor wheel (3) including the rotary shaft (2), the sleeve (4) mounted on the outer peripheral surface (21) of the rotary shaft (2), and the compressor wheel (3) including the hub (5) having the through-hole (51) into which the rotary shaft (2) is inserted along the axial direction, and the plurality of blades (6) provided on the outer peripheral surface (52) of the hub (5). The outer peripheral surface (21) of the rotary shaft (2) and the through-hole (51) of the hub (5) are joined through the interference-fit. The back surface (54) of the hub (5) includes the flat surface (56) including the contact surface (561) which protrudes to the one side (X1) in the axial direction with respect to the outer peripheral edge (541) of the back surface (54) and which comes into contact with the sleeve (4), and the recessed surface (57) formed from the outer peripheral end (562) of the flat surface (56) to the outer peripheral edge (541) of the back surface (54), the recessed surface (57) including the first line segment region (A1) extending from one end toward the other side (X2) in the axial direction when the outer peripheral end (562) of the flat surface (56) is defined as the one end, in the first line segment region (A1), the inclination angle θ1 with respect to the axial direction being 45 degrees or smaller, and the curved line (CA1) in which the inclination angle θ1 increases toward the other side (X2) in the axial direction being formed at least at a position including the other end (571) of the first line segment region (A1), and the second line segment region (A2) extending from the other end (571) of the first line segment region (A1) toward the outer peripheral side in the radial direction, in the second line segment region (A2), the inclination angle θ2 with respect to the axial direction being 45 degrees or larger and 90 degrees or smaller, and the curved line CA2 in which the inclination angle θ2 increases toward the outer peripheral side being formed at least at a position including a connecting portion (571A) connected to the first line segment region (A2). The other end (571) of the first line segment region (A1) is provided at a position on the inner peripheral side with respect to ½ of the outer dimension (D1) of the back surface (54) of the hub (5) in a direction orthogonal to the axial direction.

According to the configuration of 1), the back surface (54) of the hub (5) is formed into a shape including the flat surface (56) and the recessed surface (57) including the first line segment region (A1) and the second line segment region (A2). In this manner, while a strength decrease can be prevented on the back surface portion of the hub (5), which is a portion on the one side (X1) in the axial direction with respect to the outer peripheral edge (541) of the back surface (54) of the hub (5), it is possible to reduce the centrifugal stress acting on the back surface portion of the hub (5). In this manner, during the operation of the supercharger (11) including the mounting structure (1) of the compressor wheel (3), the through-hole (51) of the hub (5) can be prevented from being plastically deformed due to the heat or the centrifugal stress acting on the hub (5). Since the through-hole (51) of the hub (5) is prevented from being plastically deformed, when the supercharger (11) is operated or stopped, it is possible to prevent a change in the balance of the compressor wheel (3) when joining between the outer peripheral surface (21) of the rotary shaft (2) and the through-hole (51) of the hub (5) is released.

2) In some embodiments, in the compressor wheel mounting structure (1) according to 1), the recessed surface (57) includes the first curved surface (581) formed at a position including the outer peripheral end (562) of the flat surface (56) and having the first curvature (R1), and the second curved surface (583) connected to the first curved surface (581) and having the curvature (R2) smaller than the first curvature (R1).

According to the configuration of 2), the recessed surface (57) is formed into a shape including the first curved surface (581) and the second curved surface (583). In this manner, while a strength decrease can be prevented on the back surface portion of the hub (5), it is possible to reduce the centrifugal stress acting on the back surface portion of the hub (5), particularly, on the flat surface (56) side (the one side in the axial direction) with respect to the connecting portion (582) between the first curved surface (581) and the second curved surface (583).

3) In some embodiments, in the compressor wheel mounting structure (1) according to 1), the recessed surface (57) includes the first flat surface (591) formed at a position including the outer peripheral end (562) of the flat surface (56), the curved surface (593) connected to the first flat surface (591), and the second flat surface (595) connected to the curved surface (593) and formed at a position including the outer peripheral edge (541) of the back surface (54).

According to the configuration of 3), the recessed surface (57) is formed into a shape including the first flat surface (591), the curved surface (593), and the second flat surface (595). In this manner, while a strength decrease can be prevented on the back surface portion of the hub (5), it is possible to reduce the centrifugal stress acting on the back surface portion of the hub (5), particularly, on the flat surface (56) side (the one side in the axial direction) with respect to the connecting portion (594) between the second flat surface (595) and the curved surface (593).

4) In some embodiments, in the compressor wheel mounting structure (1) according to 1), the compressor wheel mounting structure (1) further includes at least one joint (7) that joins the outer peripheral surface (21) of the rotary shaft (2) and the through-hole (51) of the hub (5) through the interference-fit. The at least one joint (7) includes the one-side joint (7A) provided on the one side (X1) in the axial direction with respect to the outer peripheral edge (541) of the back surface (54).

According to the configuration of 4), the one-side joint (7A) is provided on the back surface portion of the hub (5) in which the centrifugal stress acting during the operation of the supercharger (11) is low. There is a low probability that the inner peripheral surface (53) on the back surface portion of the hub (5) may be plastically deformed during the operation of the supercharger (11). Therefore, joining by the one-side joint (7A) is maintained both when the supercharger (11) is operated and when the supercharger (11) is stopped. In this manner, a balance change risk in the compressor wheel (3) can be reduced.

5) In some embodiments, in the compressor wheel mounting structure (1) according to 1), the compressor wheel mounting structure (1) further includes at least one joint (7) that joins the outer peripheral surface (21) of the rotary shaft (2) and the through-hole (51) of the hub (5) through the interference-fit. The at least one joint (7) includes the other-side joint (7B), at least a portion of which is provided on the other side (X2) in the axial direction with respect to the leading edge (61) of the blade (6).

According to the configuration of 5), at least a portion of the other-side joint (7B) is provided in the front portion (portion on the other side in the axial direction with respect to the leading edge 61 of the blade 6 of the hub 5) of the hub (5) in which the centrifugal stress acting during the operation of the supercharger (11) is low. There is a low probability that the inner peripheral surface (53) in the front portion of the hub (5) may be plastically de formed during the operation of the supercharger (11). Therefore, joining by the other-side joint (7B) is maintained both when the supercharger (11) is operated and when the supercharger (11) is stopped. In this manner, a balance change risk in the compressor wheel (3) can be reduced.

6) In some embodiments, in the compressor wheel mounting structure (1) according to 1), the hub (5) includes the boss part (551) that protrudes toward the other side (X2) in the axial direction with respect to the leading edge (61) of the blade (6). The other-side joint (7B) is provided in the boss part (551).

According to the configuration of 6), the other-side joint (7B) is provided in the boss part (551) of the front portion of the hub (5) in which the centrifugal stress acting during the operation of the supercharger (11) is low. In this manner, compared to when the other-side joint (7B) is provided at a position other than the boss part (551) in the front portion, joining by the other-side joint (7B) is effectively maintained both when the supercharger (11) is operated and when the supercharger (11) is stopped. In this manner, a balance change risk in the compressor wheel (3) can be effectively reduced.

7) In some embodiments, in the compressor wheel mounting structure (1) according to 1), the compressor wheel mounting structure (1) further includes at least one joint (7) that joins the outer peripheral surface (21) of the rotary shaft (2) and the through-hole (51) of the hub (5) through the interference-fit. The at least one joint (7) includes the center-side joint (7C) provided on the one side (X1) in the axial direction with respect to the leading edge (61) of the blade (6) and on the other side (X2) in the axial direction with respect to the trailing edge (62) of the blade (6).

According to the configuration of 7), the center-side joint (7C) is provided in the central portion (portion on the one side X1 in the axial direction with respect to the leading edge 61 of the blade 6 of the hub 5 and on the other side X2 in the axial direction with respect to the trailing edge 62 of the blade 6) of the hub (5) in which the centrifugal stress acting during the operation of the supercharger (11) is low. There is a low probability that the inner peripheral surface (53) in the central portion of the hub (5) may be plastically deformed during the operation of the supercharger (11). Therefore, joining by the center-side joint (7C) is maintained both when the supercharger (11) is operated and when the supercharger (11) is stopped. In this manner, a balance change risk in the compressor wheel (3) can be reduced.

8) In some embodiments, in the compressor wheel mounting structure (1) according to 1), the compressor wheel mounting structure (1) further includes at least one joint (7) that joins the outer peripheral surface (21) of the rotary shaft (2) and the through-hole (51) of the hub (5) through the interference-fit. The at least one joint (7) includes the first joint (7D), and the second joint (7E) provided on the other side (X2) in the axial direction with respect to the first joint (7D).

According to the configuration of 8), in the compressor wheel mounting structure (1), the joints (first joint 7D, second joint 7E) are provided at a plurality of locations in the axial direction (X). In this manner, the compressor wheel (3) can be prevented from being tilted with respect to the rotary shaft (2), and an axial center of the compressor wheel (3) can be accurately held. In this manner, a balance change risk in the compressor wheel (3) can be reduced.)

In some embodiments, in the compressor wheel mounting structure (1) according to 8), the rotary shaft (2) includes the shaft side small-diameter portion (24) facing the inner peripheral surface (53) of the through-hole (51), and the shaft side large-diameter portion (25D) provided in the first joint (7D) and formed with a diameter larger than that of the shaft side small-diameter portion (24). The through-hole (51) includes the through-hole side large-diameter portion (511) separated in a direction orthogonal to the axial direction with respect to the shaft side small-diameter portion (24), and the through-hole side small-diameter portion (512E) provided in the second joint (7E) and formed with a diameter smaller than that of the through-hole side large-diameter portion (511).

According to the configuration of 9), the first joint (7D) is formed in such a manner that the outer peripheral surface of the shaft side large-diameter portion (25D) and the inner peripheral surface of the through-hole side large-diameter portion (511) are joined through the interference-fit. In addition, the second joint (7E) is formed in such a manner that the outer peripheral surface of the shaft side small-diameter portion (24) and the inner peripheral surface of the through-hole side small-diameter portion (512E) are joined through the interference-fit. The diameter of the rotary shaft (2) in the first joint (7D) is increased, and the diameter of the through-hole (51) in the second joint (7E) is decreased. In this manner, the rotary shaft (2) is easily inserted into the through-hole (51) of the compressor wheel (3) from the one side (X1) toward the other side (X2) in the axial direction. In this manner, the compressor wheel (3) and the rotary shaft (2) are satisfactorily assembled. In addition, according to the configuration of 9), compared to when a plurality of the shaft side large-diameter portions (25D and 25E) are formed in the rotary shaft (2), or when a plurality of the through-hole side small-diameter portions (512D and 512E) are formed in the hub (5), the rotary shaft (2) or the hub (5) is easily formed. Therefore, manufacturing costs of the rotary shaft (2) or the hub (5) can be reduced.

10) In some embodiments, in the compressor wheel mounting structure (1) according to 8), The through-hole (51) includes the through-hole side large-diameter portion (511) separated in a direction orthogonal to the axial direction with respect to the rotary shaft (2), the first through-hole side small-diameter portion (512D) provided in the first joint (7D) and formed with a diameter smaller than that of the through-hole side large-diameter portion (511), and the second through-hole side small-diameter portion (512E) provided in the second joint (7E) and formed with a diameter smaller than that of the through-hole side large-diameter portion (511).

According to the configuration of 10), the first joint (7D) is formed in such a manner that the inner peripheral surface of the first through-hole side small-diameter portion (512D) and the outer peripheral surface of the rotary shaft (2) are joined through the interference-fit. In addition, the second joint (7E) is formed in such a manner that the inner peripheral surface of the second through-hole side small-diameter portion (512E) and the outer peripheral surface of the rotary shaft (2) are joined through the interference-fit. In this case, the shaft side large-diameter portion as described above may not be formed in the rotary shaft (2), and the rotary shaft (2) is easily formed. Therefore, manufacturing costs of the rotary shaft (2) can be reduced.

11) In some embodiments, in the compressor wheel mounting structure (1) according to 8), the rotary shaft (2) includes the shaft side small-diameter portion (24) separated in a direction orthogonal to the axial direction with respect to the inner peripheral surface (53) of the through-hole (51), the first shaft side large-diameter portion (25D) provided in the first joint (7D) and formed with a diameter larger than that of the shaft side small-diameter portion (24), and the second shaft side large-diameter portion (25E) provided in the second joint (7E) and formed with a diameter larger than that of the shaft side small-diameter portion (24).

According to the configuration of 11), the first joint (7D) is formed in such a manner that the outer peripheral surface of the first shaft side large-diameter portion (25D) and the inner peripheral surface of the through-hole (51) of the hub (5) are joined through the interference-fit. In addition, the second joint (7E) is formed in such a manner that the outer peripheral surface of the second shaft side large-diameter portion (25E) and the inner peripheral surface of the through-hole (51) of the hub (5) are joined through the interference-fit. In this case, the through-hole side small-diameter portion as described above may not be formed in the through-hole (51) of the hub (5), and the through-hole (51) is easily formed. Therefore, manufacturing costs of the compressor wheel (3) can be reduced.

12) In some embodiments, in the compressor wheel mounting structure (1) according to 8), the first joint (7D) is provided on the one side (X1) in the axial direction with respect to the outer peripheral edge (541) of the back surface (54).

According to the configuration of 12), the first joint (7D) is provided on the back surface portion of the hub (5) in which the centrifugal stress acting during the operation of the supercharger (11) is low. There is a low probability that the inner peripheral surface of the back surface portion of the hub (5) may be plastically deformed during the operation of the supercharger (11). Therefore, joining by the first joint (7D) is maintained both when the supercharger (11) is operated and when the supercharger (11) is stopped. In addition, the second joint (7E) is provided in the front portion or the central portion of the hub (5) in which the centrifugal stress acting during the operation of the supercharger (11) is low. In this manner, joining by the second joint (7E) is maintained both when the supercharger (11) is operated and when the supercharger (11) is stopped. Therefore, the compressor wheel (3) can be effectively prevented from being tilted with respect to the rotary shaft (2), and an axial center of the compressor wheel (3) can be accurately held. In this manner, a balance change risk in the compressor wheel (3) can be effectively reduced.

13) The supercharger (11) according to at least one embodiment of the present disclosure includes the compressor wheel mounting structure (1) according to 1).

According to the configuration of 13), during the operation of the supercharger (11), the through-hole (51) of the hub (5) can be prevented from being plastically deformed due to the heat or the centrifugal stress acting on the hub (5). In this manner, when the supercharger (11) is operated or stopped, joining between the outer peripheral surface (21) of the rotary shaft (2) and the through-hole (51) of the hub (5) can be prevented from being released. Therefore, a change in the balance of the compressor wheel (3) can be prevented.

### REFERENCE SIGNS LIST

1, 01: Compressor wheel mounting structure
2: Rotary shaft
3: Compressor wheel
4: Sleeve
5: Hub
6: Blade
7, 07: Joint
7A: One-side joint
7B: Other-side joint
7C: Center-side joint
7D: First joint
7E: Second joint
11: Supercharger
12: Casing
13: Turbine blade
14: Bearing
15: Compressor housing
16: Turbine housing
17: Bearing housing
18: Nut member
19: Thrust ring
21: Outer peripheral surface
22: Stepped surface
23: Other end portion
24: Shaft side small-diameter portion
25: Shaft side large-diameter portion
41: Through-hole
42: End surface
51: Through-hole
52: Outer peripheral surface
53: Inner peripheral surface
54, 054: Back surface
55: Other side flat surface
56, 056: Flat surface
57, 057: Recessed surface
61: Leading edge
62: Trailing edge
63: Tip-side edge
70, G: Gap
A1: First line segment region
A2: Second line segment region
LA: Axis
P0: Axial position
R1, R2: Curvature
X: Axial direction
X1: One side (in axial direction)
X2: Other side (in axial direction)
Y: Radial direction

1. A compressor wheel mounting structure comprising:
a rotary shaft,
a sleeve mounted on an outer peripheral surface of the rotary shaft, and
a compressor wheel including a hub having a through-hole into which the rotary shaft is inserted along an axial direction, and a plurality of blades provided on an outer peripheral surface of the hub,
wherein the outer peripheral surface of the rotary shaft and the through-hole of the hub are joined through interference-fit,
a back surface of the hub includes
a flat surface including a contact surface which protrudes to one side in the axial direction with respect to an outer peripheral edge of the back surface and which comes into contact with the sleeve, and
a recessed surface formed from an outer peripheral end of the flat surface to the outer peripheral edge of the back surface, the recessed surface including
a first line segment region extending from one end toward the other side in the axial direction when the outer peripheral end of the flat surface is defined as the one end, in the first line segment region, an inclination angle θ1 with respect to the axial direction being 45 degrees or smaller, and a curved line in which the inclination angle θ1 increases toward the other side in the axial direction being formed at least at a position including the other end of the first line segment region, and
a second line segment region extending from the other end of the first line segment region toward an outer peripheral side in a radial direction, in the second line segment region, an inclination angle θ2 with respect to the axial direction being 45 degrees or larger and 90 degrees or smaller, and a curved line in which the inclination angle θ2 increases toward the outer peripheral side being formed at least at a position including a connecting portion connected to the first line segment region, and
the other end of the first line segment region is provided at a position on an inner peripheral side with respect to ½ of an outer dimension of the back surface of the hub in a direction orthogonal to the axial direction.

2. The compressor wheel mounting structure according to claim 1,
wherein the recessed surface includes
a first curved surface formed at a position including the outer peripheral end of the flat surface and having a first curvature, and
a second curved surface connected to the first curved surface and having a curvature smaller than the first curvature.

3. The compressor wheel mounting structure according to claim 1,
wherein the recessed surface includes
a first flat surface formed at a position including the outer peripheral end of the flat surface,
a curved surface connected to the first flat surface, and
a second flat surface connected to the curved surface and formed at a position including the outer peripheral edge of the back surface.

4. The compressor wheel mounting structure according to claim 1, further comprising:
at least one joint that joins the outer peripheral surface of the rotary shaft and the through-hole of the hub through the interference-fit,
wherein the at least one joint includes a one-side joint provided on the one side in the axial direction with respect to the outer peripheral edge of the back surface.

5. The compressor wheel mounting structure according to claim 1, further comprising:
at least one joint that joins the outer peripheral surface of the rotary shaft and the through-hole of the hub through the interference-fit,
wherein the at least one joint includes an other-side joint, at least a portion of which is provided on the other side in the axial direction with respect to a leading edge of the blade.

6. The compressor wheel mounting structure according to claim 5,
wherein the hub includes a boss part that protrudes toward the other side in the axial direction with respect to the leading edge of the blade, and
the other-side joint is provided in the boss part.

7. The compressor wheel mounting structure according to claim 1, further comprising:
at least one joint that joins the outer peripheral surface of the rotary shaft and the through-hole of the hub through the interference-fit,
wherein the at least one joint includes a center-side joint provided on the one side in the axial direction with respect to a leading edge of the blade and on the other side in the axial direction with respect to a trailing edge of the blade.

8. The compressor wheel mounting structure according to claim 1, further comprising:
at least one joint that joins the outer peripheral surface of the rotary shaft and the through-hole of the hub through the interference-fit,
wherein the at least one joint includes
a first joint, and
a second joint provided on the other side in the axial direction with respect to the first joint.

9. The compressor wheel mounting structure according to claim 8,
wherein the rotary shaft includes
a shaft side small-diameter portion facing an inner peripheral surface of the through-hole, and
a shaft side large-diameter portion provided in the first joint and formed with a diameter larger than that of the shaft side small-diameter portion, and
the through-hole includes
a through-hole side large-diameter portion separated in a direction orthogonal to the axial direction with respect to the shaft side small-diameter portion, and
a through-hole side small-diameter portion provided in the second joint and formed with a diameter smaller than that of the through-hole side large-diameter portion.

10. The compressor wheel mounting structure according to claim 8,
wherein the through-hole includes
a through-hole side large-diameter portion separated in a direction orthogonal to the axial direction with respect to the rotary shaft,
a first through-hole side small-diameter portion provided in the first joint and formed with a diameter smaller than that of the through-hole side large-diameter portion, and
a second through-hole side small-diameter portion provided in the second joint and formed with a diameter smaller than that of the through-hole side large-diameter portion.

11. The compressor wheel mounting structure according to claim 8,
wherein the rotary shaft includes
a shaft side small-diameter portion separated in a direction orthogonal to the axial direction with respect to an inner peripheral surface of the through-hole,
a first shaft side large-diameter portion provided in the first joint and formed with a diameter larger than that of the shaft side small-diameter portion, and
a second shaft side large-diameter portion provided in the second joint and formed with a diameter larger than that of the shaft side small-diameter portion.

12. The compressor wheel mounting structure according to claim 8,
wherein the first joint is provided on the one side in the axial direction with respect to the outer peripheral edge of the back surface.

13. A supercharger comprising:
the compressor wheel mounting structure according to claim 1.
